(19) United States
(12) Patent Application Publication
(10) Pub. No.: US 2023/0112894 A1
(43) Pub. Date: Apr. 13, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Toru Suneya, Kanagawa (JP)

(21) Appl. No.: 17/938,527

(22) Filed: Oct. 6, 2022

(30) Foreign Application Priority Data
Oct. 7, 2021 (JP) 2021-165649

(51) Int. Cl. H04L 65/60; G06V 20/64; H04N 5/278; H04N 5/265

(52) U.S. Cl. CPC H04L 65/60; G06V 20/64; H04N 5/278; H04N 5/265

(57) ABSTRACT

There is provided with an information processing apparatus. A generating unit generates a playlist including a network address that is referred to for acquisition of an image, region information defining a spatial partial region in the image, and annotation information that is information to be displayed in association with the partial region. A sending unit sends the playlist generated by the generating unit.

### BACKGROUND

### Field of the Disclosure

The present disclosure relates to an information processing apparatus, an information processing method, and a storage medium.

### Description of the Related Art

There is a system that distributes streaming content constituted by speech data, video data, and the like in real time so as to allow the user to view such content via a terminal apparatus of his/her own. In this case, the terminal apparatus has various functions and plays back content in various environments. For this reason, there is a demand for an adaptive technology for content playback with respect to environments.

### SUMMARY

According to one embodiment of the present disclosure, an information processing apparatus comprises: a generating unit configured to generate a playlist including a network address that is referred to for acquisition of an image, region information defining a spatial partial region in the image, and annotation information that is information to be displayed in association with the partial region; and a sending unit configured to send the playlist generated by the generating unit.

According to another embodiment of the present disclosure, an information processing apparatus comprises: a receiving unit configured to receive a playlist including a network address that is referred to for acquisition of an image, region information defining a spatial partial region in the image, and annotation information that is information to be displayed in association with the partial region; an analyzing unit configured to analyze the received playlist; an acquiring unit configured to acquire the image corresponding to the network address based on the analysis result; and a display unit configured to display the partial region and the annotation information while superimposing the partial region and the annotation information on the image.

According to still another embodiment of the present disclosure, an information processing method comprises: generating a playlist including a network address that is referred to for acquisition of an image, region information defining a spatial partial region in the image, and annotation information that is information to be displayed in association with the partial region; and sending the generated playlist.

According to yet another embodiment of the present disclosure, an information processing method comprises: receiving a playlist including a network address that is referred to for acquisition of an image, region information defining a spatial partial region in the image, and annotation information that is information to be displayed in association with the partial region; analyzing the received playlist; acquiring the image corresponding to the network address based on the analysis result; and displaying the partial region and the annotation information while superimposing the partial region and the annotation information on the image.

According to yet still embodiment of the present disclosure, a non-transitory computer-readable storage medium stores a program which, when executed by a computer comprising a processor and a memory, causes the computer to: generate a playlist including a network address that is referred to for acquisition of an image, region information defining a spatial partial region in the image, and annotation information that is information to be displayed in association with the partial region; and send the generated playlist.

Further features of the present disclosure will become apparent from the following description of exemplary embodiments (with reference to the attached drawings).

### BRIEF DESCRIPTION OF THE DRAWINGS

FIG. 1 is a block diagram showing an example of the configuration of a system including an information processing apparatus according to one or more aspects of the present disclosure;

FIG. 2 is a block diagram showing an example of the functional configuration of the information processing apparatus according to one or more aspects of the present disclosure;

FIG. 3 is a view showing an example of the box configuration of an image file according to one or more aspects of the present disclosure;

FIG. 4A is a view showing a display example of annotation information set by the information processing apparatus according to one or more aspects of the present disclosure;

FIG. 4B is a view showing the relationship between the respective items set by the information processing apparatus according to one or more aspects of the present disclosure;

FIG. 5 is a flowchart showing an example of playlist generation processing according to one or more aspects of the present disclosure;

FIGS. 6A and 6B are views showing an example of a playlist generated by the information processing apparatus according to one or more aspects of the present disclosure;

FIGS. 7A and 7B are views showing an example of a playlist generated by the information processing apparatus according to one or more aspects of the present disclosure;

FIGS. 8A and 8B are views showing an example of a playlist generated by the information processing apparatus according to one or more aspects of the present disclosure;

FIGS. 9A and 9B are views showing an example of a playlist generated by the information processing apparatus according to one or more aspects of the present disclosure;

FIGS. 10A and 10B are views showing an example of a playlist generated by the information processing apparatus according to one or more aspects of the present disclosure;

FIGS. 11A and 11B are views showing an example of a playlist generated by the information processing apparatus according to one or more aspects of the present disclosure;

FIGS. 12A and 12B are views showing an example of a playlist generated by the information processing apparatus according to one or more aspects of the present disclosure;

FIG. 13 is a view showing an example of a playlist generated by the information processing apparatus according to one or more aspects of the present disclosure;

FIG. 14 is a view showing an example of a playlist generated by an information processing apparatus according to one or more aspects of the present disclosure;

FIG. 15 is a flowchart showing an example of display processing performed by a receiving apparatus according to one or more aspects of the present disclosure; and

FIG. 16 is a block diagram showing an example of the hardware configuration according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

Playlists, which are files distributed for the purpose of distributing an arbitrary image and different from image data have not been configured to be provided with annotation information to be displayed in association with a partial region of a video.

The present disclosure has an object to provide a file different from image data used for the distribution of an image with annotation information associated with a partial region in the image.

### First Embodiment

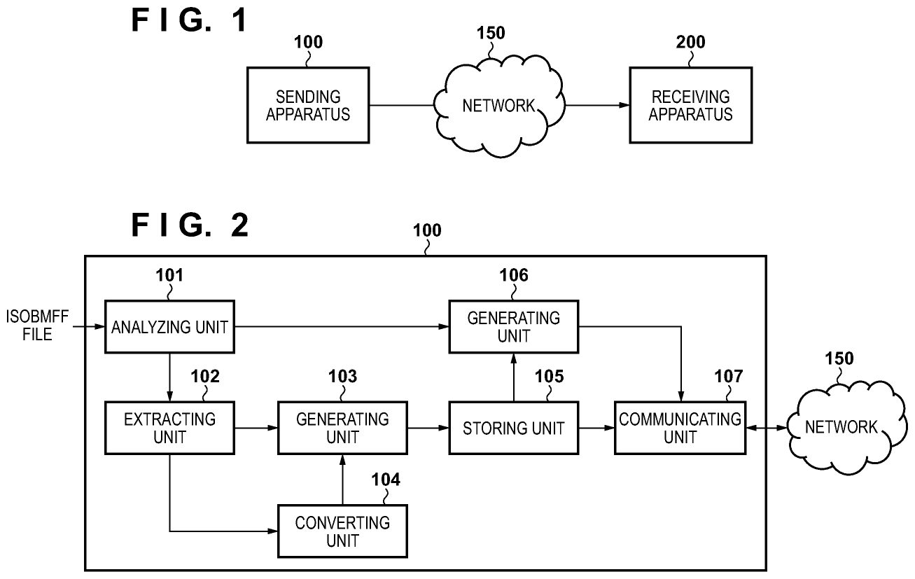

FIG. 1 shows an example of a system including an information processing apparatus according to this embodiment. An information processing apparatus 100 according to the embodiment is a sending apparatus that sends image data (image) to a receiving apparatus 110. In the system shown in FIG. 1, the information processing apparatus 100 is communicably connected to the receiving apparatus 110 via a network 120. The number of information processing apparatuses 100 and the number of receiving apparatuses 110 each are not limited to one but may be two or more.

The information processing apparatus 100 generates a playlist including a network address to be referred to for the acquisition of an image and sends the playlist together with the image to the receiving apparatus 110. The information processing apparatus 100 can be, for example, a camera, a video camera, a portable terminal such as a smartphone, a PC (Personal Computer), or a cloud server. However, the information processing apparatus 100 is not limited to them as long as the apparatus can execute each function to be described later. Note that an image to be transmitted in this case may be a moving image (video) but indicates one still image for the sake of descriptive convenience.

The receiving apparatus 110 receives data from the information processing apparatus 100. The receiving apparatus 110 includes a playback/display function for content such as an image and may accept an input from the user. As the receiving apparatus 110 according to this embodiment, a desired electronic device, for example, a portable terminal such as a smartphone, a PC, or a TV set can be used.

The network 120 can be any one of various types of networks such as the Internet/intranet or LAN (Local Area Network)/WAN (Wide Area Network). The wired communication interface can be an interface complying with the Ethernet® standards but may be another type of interface. The wireless communication interface may be an interface complying with the wireless LAN standards complying with the IEEE802.11 standard series or an interface complying with WAN, Bluetooth® standards such as 3G/4G/LTE standards. Note that as a wireless connection form, a connection form in an infrastructure network or a connection form in an adhoc network may be used. In addition, the network 120 may be a combination of a wired communication path and a wireless communication path. That is, the network 120 may have an arbitrary form as long as it establishes connection between the information processing apparatus 100 and the receiving apparatus 110 and allows communication between them.

This embodiment uses standards called MPEG (Moving Picture Experts Group)—DASH (Dynamic Adaptive Streaming over Http) of ISO/IEC23009-1. Assume in the following description that each process such as playlist generation processing (to be described later) is performed by using MPEG-DASH standards.

MPEG (Moving Picture Experts Group)—DASH (Dynamic Adaptive Streaming over Http) standards will be described below. MPEG-DASH is video distribution standards that can dynamically change acquired streams.

MPEG-DASH can divide media data into segments each having a predetermined time length and describe URLs (Uniform Resource Locators) for acquiring segments in a file called a playlist. The receiving apparatus can acquire this playlist first and then acquire a desired segment by requesting it from the sending apparatus using information described in the playlist. In addition, describing URLs for segments in a plurality of versions different in bit rate and resolution in the playlist allows the receiving apparatus to acquire a segment in an optimal version in accordance with the performance of the receiving apparatus itself, a communication environment, and the like. ISO Base Media File Format (to be referred to as ISOBMFF hereinafter) is used as the file format of the segment.

The configuration of ISOBMFF is roughly divided into a portion storing header information and a portion storing encoded data. The header information includes information indicating the size and time stamp of the encoded data stored in the segment. As the encoded data, a moving image, still image, speech data, or the like can be stored. ISOBMFF includes a plurality of extension standards according to the types of encoded data to be stored. One of the extension standards is HEIF (High Efficiency Image File Format) standardized by MPEG. HEIF is in the process of standardization under the title of “Image File Format” in ISO/IEC 23008-12 (Part12) and defines specifications for the storage of still images encoded by HEVC (High Efficiency Video Coding), which is a codec mainly used for moving images, and an image sequence. In addition, ISOBMFF can store metadata such as a text or XML, other than media data such as the above moving images and store the meta data not only as static information but also as dynamic information. In particular, metadata having information in a time-series manner is called timed metadata, which is typically subtitle data.

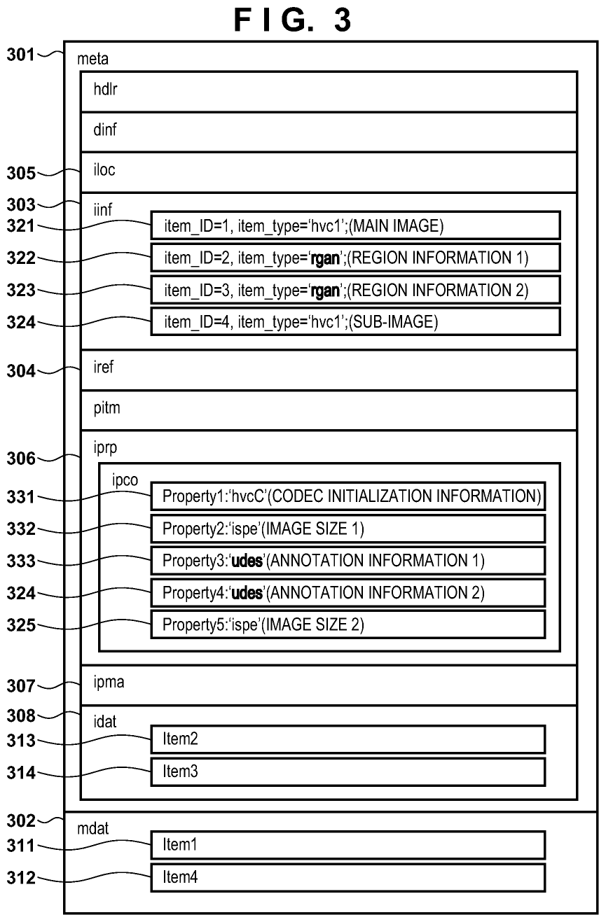

FIG. 2 is a block diagram showing an example of the functional configuration of the information processing apparatus according to this embodiment. The information processing apparatus 100 includes an analyzing unit 101, an extracting unit 102, a generating unit 103, a converting unit 104, a storing unit 105, a generating unit 106, and a communicating unit 107. The details of processing performed by each functional unit will be described later with reference to FIGS. 3 to 7.

The analyzing unit 101 analyzes the structure of a data file. Assume that in the following description, the data file to be analyzed by the analyzing unit 101 has the HEIF file format. The extracting unit 102 extracts metadata and encoded data stored in the data file based on the analysis result on the data file obtained by the analyzing unit 101.

The generating unit 103 divides the metadata and the encoded data extracted by the extracting unit 102 into data each having a time length suitable for communication as needed or changes the bit rates, thereby generating segments storing the respective data. The converting unit 104 can convert extracted encoded data into a different coding format as needed. Note that the generating unit 103 may store encoded data converted by the converting unit 104 in a segment. The storing unit 105 stores the data generated by the generating unit 103.

The generating unit 106 generates a playlist including a network address to be referred to by the receiving apparatus 110 to acquire data stored in the storing unit 105 based on an analysis result on a data file. The playlist includes region information defining a partial region on an image included in the data file and annotation information as information displayed in association with the partial region.

As a network address included in a playlist in this case, a URI (Uniform Resource Identifier) is basically used. The generating unit 106 may describe a URL or an Internet or LAN IP address as a network address. The format of the network address is not specifically limited as long as it can describe the location of the data.

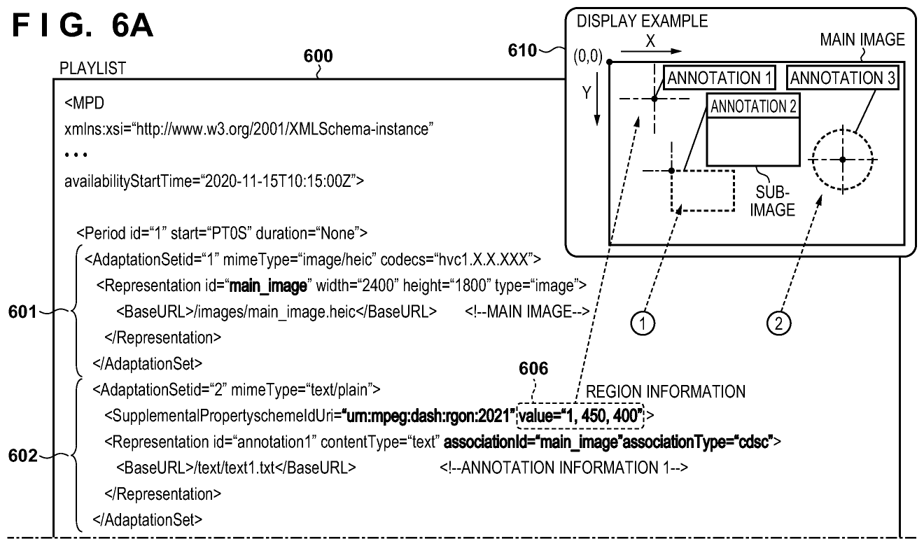

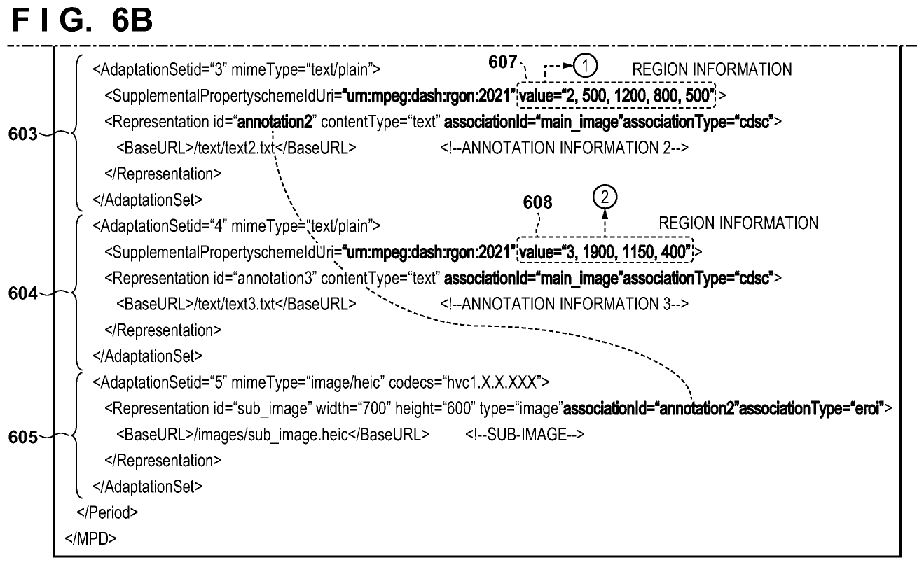

A partial region can be set on an image by an arbitrary technique. For example, the generating unit 106 may perform image analysis processing for an image input to the information processing apparatus 100 and set a region satisfying a predetermined condition as a partial region. For example, when a predetermined object is detected by image analysis, the generating unit 106 may set a bounding box indicating the object as a partial region defined by region information. In addition, when, for example, a predetermined event is detected by context analysis, the generating unit 106 may set a region in which the predetermined event has occurred as a partial region. Alternatively, the generating unit 106 may accept an input from the user and set a region designated by the user as a partial region. Although the position and shape of a partial region and the manner of how the partial region is described in a playlist are not specifically limited, the details of them will be described later with reference to FIGS. 6 to 13.

Annotation information is information to be displayed in association with a partial region as described above. For example, annotation information is information to be displayed while being superimposed on an image in association with a partial region like annotation information 1 to 3 in FIGS. 6A and 6B (to be described later). The manner of how annotation information is displayed is not limited to being superimposed on an image in the above manner as long as the display indicates that the annotation information is associated with the partial region. For example, annotation information may be displayed on another screen or displayed in the form of a list in another frame of a moving image. Annotation information can take a desired form as long as it can be displayed and played back in association with a partial region and may be, for example, text information constituted by characters, symbols, or the like or an image or video or may include speech. These pieces of annotation information may be information output as a result of image analysis, information input by the user, or externally acquired information. Assume that in this embodiment, these pieces of information are stored and defined in each box shown in FIG. 3 as metadata or encoded data. That is, for example, the information processing apparatus according to the embodiment can generate a playlist that provides a video (for example, saved in the cloud) with a partial region and annotation information and send the playlist to the user who needs the annotation information. This makes it possible to present the user with, for example, a monitoring-required target detected by a monitoring camera or a target demanding attention such as a hidden target by displaying annotation information.

The generating unit 106 includes, in a playlist, annotation information to be displayed in association with a partial region on still image data constituting video data stored in a HEIF file based on the analysis result obtained by the analyzing unit 101. The configuration of a HEIF file analyzed by the analyzing unit 101 will be described with reference to FIG. 3. FIG. 3 is a view showing an example of the configuration of a data file (HEIF file) serving as an analysis target by the information processing apparatus 100 and storing annotation information.

In this embodiment, the analyzing unit 101 analyzes nested boxes constituting a HEIF file and acquires each piece of information included in the image file by using the extracting unit 102. In this embodiment, each box of a HEIF file is identified by a four-character identifier and stores information for each use. In the following description, each box is represented by a four-character identifier assigned to the box. In the example shown in FIG. 3, the HEIF file includes meta 301 and mdat 302 as boxes.

The meta (MetaDataBox) 301 is a box storing meta data and includes, as boxes, hdlr, dinf, iloc 305, iinf 303, iref 304, pitm, iprp 306, ipma 307, and idat 308. The meta 301 can store various types of information such as information concerning the ID of each item of each of image and speech files, and information concerning the encoding of media data or information concerning a method of storing the media data in the HEIF file.

Although item data can be stored in mdat 302, the data may be stored in the idat 308 in the meta 301. In the case shown in FIG. 3, item 313 and item 314 are stored in the idat 308 in the meta 301, and item 311 and item 312 are stored in the mdat 302. In this case, a still image, video, or speech information item is stored in the mdat 302. The item stored in the idat 308 is an item indicating region information or annotation information. As described above, in this embodiment, video data, speech data, or the like is stored in the mdat 302, and annotation information having a relatively small size, such as text data, region information, or the like is stored in the idat 308.

The hdlr (HandlerRferenceBox) stores handler type information for identifying the structure and format of content included in meta.

The iinf (ItemInformationBox) 303 stores information indicating the identifiers for identifying all stored items, including the image items of the images in the HEIF file, and the types of items. Item information is information indicating the ID (item ID) of each item in the HEIF file, an item type indicating the type of the item, and the name of the item. The iinf 303 can also store item information when region information indicating a partial region in the Exif data generated when image data is captured by a digital camera or image data stored as an item is stored as an item.

The iref (ItemReferenceBox) 304 is a box storing association information between items and stores, for example, association information between a still image and Exif data or between a still image and region information and defines a reference type according to the relationship of association between items. For example, as a type of association between items concerning the region information, cdsc intending to provide an item at the reference destination with explanatory information is defined. In this embodiment, association information includes information indicating annotation information displayed in association with a partial region of video data (a constituent image). In addition, association information may include association information between image data and Exif data.

The iloc (ItemLocationBox) 305 stores information indicating the ID of each of items such as an image and its encoded data in the HEIF file (that is, the identification information of each image) and a storage place (location). In each process performed by the information processing apparatus 100, information indicating where item data defined in the HEIF file is located can be acquired by referring to the iloc 305. The iloc 305 includes a construction method as information indicating the storage place of each item. For example, when the reference type defined by the iref 304 is cdsc, “1” indicating that the storage place of the item is the idat 308 is generally often defined as a construction method. In the example shown in FIG. 3, the item 313 or the item 314 stored in the idat 308 is an item storing region information.

The iprp (ItemPropertyBox) 306 stores the attribute information of an image in the image file. Accordingly, the iprp 306 includes an ipco box and an ipma box. Attribute information is information concerning the display of an image, such as the width and height of the image and the number and bit length of color components. In the example shown in FIG. 3, the iprp 306 stores five properties including Property 331, Property 332, Property 333, Property 334, and Property 335. In this example, the Property 331 is codec initialization information for encoded data, the Property 332 and the Property 335 each are information indicating the size of the image, and the Property 333 and the Property 334 each are annotation information associated with a partial region of the image.

The ipma (ItemPropertyAssociationBox) 307 stores information indicating association between the information stored in ipco and an item ID. In the example shown in FIG. 3, the Property 331 and the Property 332 are associated with the item 311, the Property 331 and the Property 335 are associated with the item 312, the Property 333 is associated with the item 313, and the Property 334 is associated with the item 314. That is, each codec initialization information and image size information are associated with the item 311 and the item 312 as image items, and each annotation information is associated with a corresponding one of the item 313 and the item 314 as a region information item.

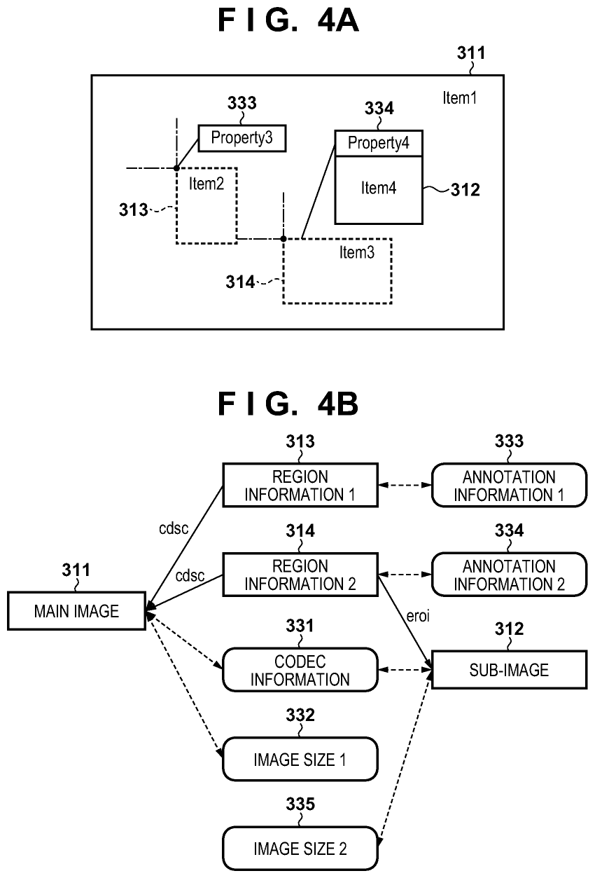

Subsequently, the relationship between the items and the properties stored in the HEIF file having the configuration described with reference to FIG. 3 will be described below with reference to FIGS. 4A and 4B. Referring to FIG. 4A, the item 311 is a main image, and the item 313 and the item 314 indicated by the dotted lines each are region information indicating a partial region on the main image. Assume that in this case, the main image is an overall image on which partial regions are set, and the sub-image is an image displayed as annotation information. The Property 333 and the Property 334 are pieces of annotation information respectively associated with the item 313 and the item 314 and are displayed as pieces of information respectively linked to the partial regions in the example shown in FIG. 4A. In addition, the item 312 is a sub-image associated with the region indicated by the item 314 and may be displayed in combination with the Property 334 that is annotation information provided to the item 314.

FIG. 4B is a view showing the relationship between the items and the properties stored in the HEIF file, which are indicated by the iref 304 and the ipma 307 in FIG. 3. In this case, there are two pieces of region information indicating partial regions, and the items are associated with each other by reference type cdsc described in the iref 304. Likewise, the sub-images as image items are associated with the region information items in the iref 304, and eroi (encoded region of interest) indicating encoded region-of-interest information is used as a reference type. Referring to FIG. 4B, each property is indicated by a rectangle with rounded corners, and each item is indicated by a rectangle.

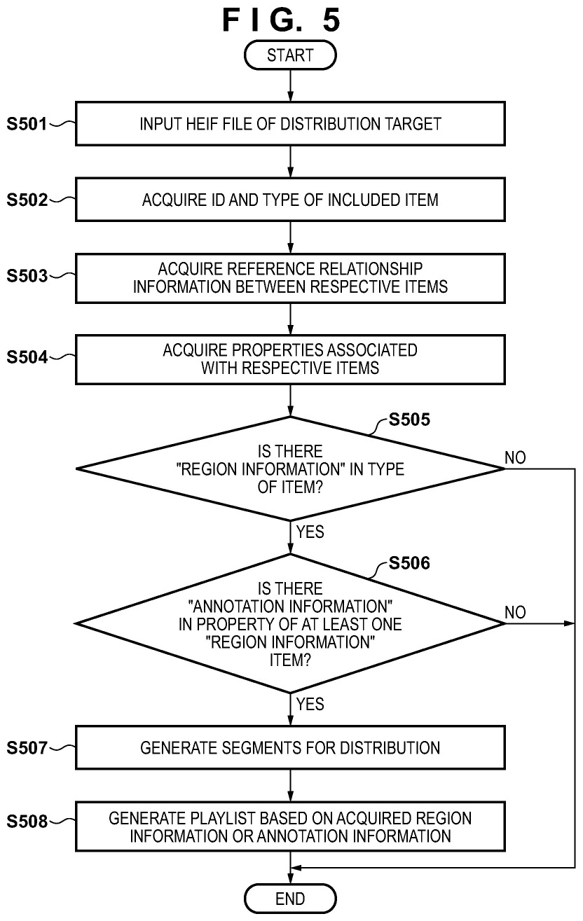

FIG. 5 shows an example of the processing performed by the information processing apparatus 100 according to this embodiment to generate a playlist by analyzing an input HEIF file. Note that in MPEG-DASH, a file corresponding to a playlist is called MPD (Media Presentation Description).

In step S501, the information processing apparatus 100 acquires an HEIF file as an analysis target. In this case, the information processing apparatus 100 acquires an HEIF file from, for example, an imaging device (not shown). In step S502, the analyzing unit 101 acquires item IDs as the identifiers of the respective items included in the HEIF file and item types by analyzing the file.

In step S503, the analyzing unit 101 acquires a reference relationships including reference types between the items based on the item IDs with reference to the ipma 307. In step S504, the analyzing unit 101 acquires properties associated with the respective items.

In step S505, the analyzing unit 101 determines whether any of the acquired items includes region information indicating a partial region in the items obtained in step S502. If YES in step S505, the process advances to step S506. If NO in step S505, the processing is terminated upon determining that there is no annotation information.

In step S506, the analyzing unit 101 determines whether a property associated with at least one region information item includes annotation information. If YES in step S506, the process advances to step S507. If NO in step S506, the processing is terminated upon determining that there is no annotation information.

In step S507, the generating unit 103 generates segments for distribution. In this case, when, for example, a plurality of items are stored in a HEIF file, the generating unit 103 generates one file for each still image item. In step S508, the generating unit 106 generates a playlist based on annotation information and terminates the processing.

An example of a playlist generated by the generating unit 106 will be described next with reference to FIGS. 6A and 6B. The generating unit 106 can generate, for example, the playlists shown in FIGS. 6 to 14. FIGS. 6A and 6B show an example of a playlist according to this embodiment and, more specifically, a description example that arbitrarily allows acquisition of annotation information provided to a partial region of still image data.

A playlist 600 shown in FIGS. 6A and 6B indicate part of MPD. A display example 610 is the display of the images, the region information, and the annotation information described in the playlist 600. The playlist 600 describes information for the acquisition of segments of a main image 601, pieces of annotation information 602 to 604, and a sub-image 605. In addition, pieces of region information 606 to 608 are described as the pieces of attribute information of the pieces of annotation information 602 to 604.

In the example shown in FIGS. 6A and 6B, the generating unit 106 defines region information using a URN such as “urn:mpeg:dash:rgon:2021”, with the numerical values or symbols described after “value=” indicating region information. As described above, the generating unit 106 can define various types of information including region information by using a schema for description interpretation and describe information for the acquisition of the schema. In this case, the generating unit 106 can describe the first value after “value=” as information defining the shape (type) of a partial region. For example, when a partial region has a point, rectangular, or circular shape, the generating unit 106 describes the first value after “value=” as “1”, “2”, or “3”.

The generating unit 106 can describe the coordinates of partial region following the shape of the partial region. In this case, the description of coordinates differs in number and meaning according to the shape of a partial region. For example, when a partial region has a point shape, the generating unit 106 may describe, as coordinate information, one parameter indicating vertical and horizontal coordinates (XY coordinates) within the main image. In the example shown in FIGS. 6A and 6B, the parameter “450, 400” in the region information 606 indicates X- and Y-axis coordinates with the upper left corner of the main image being the origin.

In the region information 607 representing a rectangular partial region, two parameters indicating the horizontal and vertical sizes of the rectangle may be described in addition to a parameter indicating the coordinates of the upper left corner of the rectangle. In the region information 608 representing a circular partial region, three parameters indicating the center coordinates of the circle and the radius length may be described. In addition, adding a rotation angle as a parameter can define region information with an ellipse angle. The shapes of partial regions are not limited to those described above, and any desired shape can be used as long as the shape can be represented by parameters. Note that when a plurality of partial regions include partial regions having an identical shape, the generating unit 106 may describe such partial regions as one element.

With regard to association between the main image and the annotation information, the generating unit 106 sets the representation ID of the main image in “associationId” as the attribute information of the representation of the annotation information. The generating unit 106 describes a type indicating the attribute of the annotation information in “associationType”. In this case, “cdsc” is set in “associationType” to indicate the annotation information with respect to the main image. In addition, since the sub-image is an image associated with a partial region of annotation information 603, “eroi” is set in “associationType” of the annotation information 603.

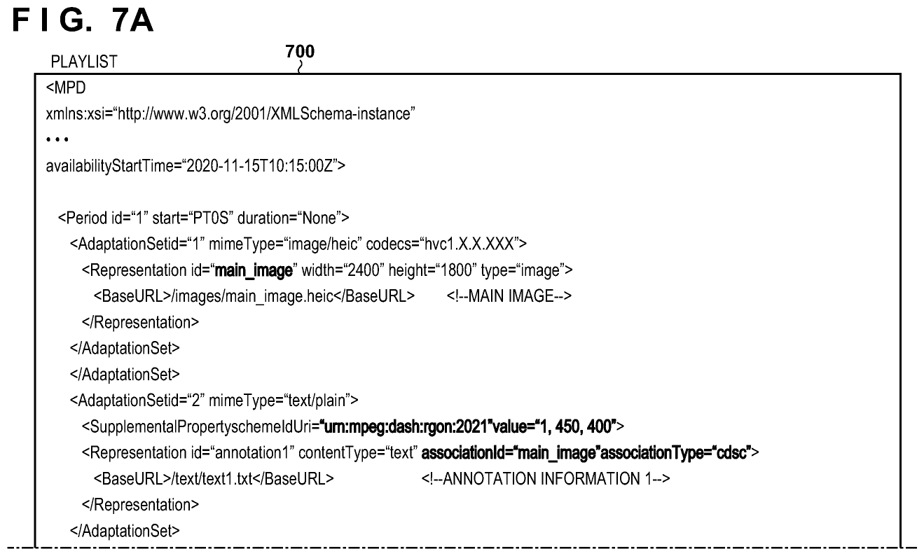

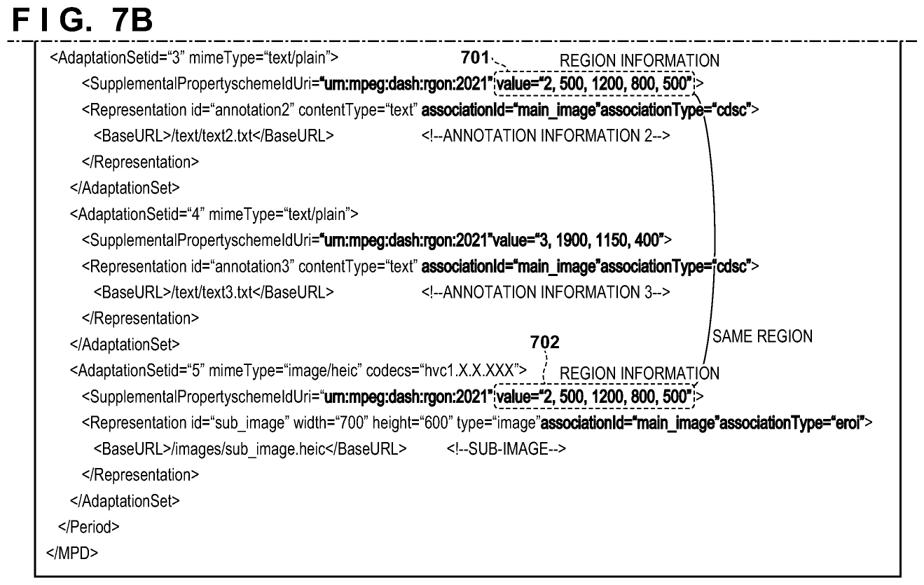

FIGS. 7A and 7B are a view for explaining an example of describing a playlist different from that shown in FIGS. 6A and 6B concerning a method of associating a sub-image with annotation information. FIGS. 7A and 7B show, in particular, an example of description for association between annotation information provided to a partial region of an image and another image.

In a playlist 700, region information 701 and region information 702 indicate the same region. In the example shown in FIGS. 6A and 6B, a sub-image is associated with annotation information having region information as attribute information to indirectly associate the sub-image with the region information. In contrast to this, in the playlist 700, region information is provided as the attribute information of a sub-image. That is, the sub-image is directly associated with the region information.

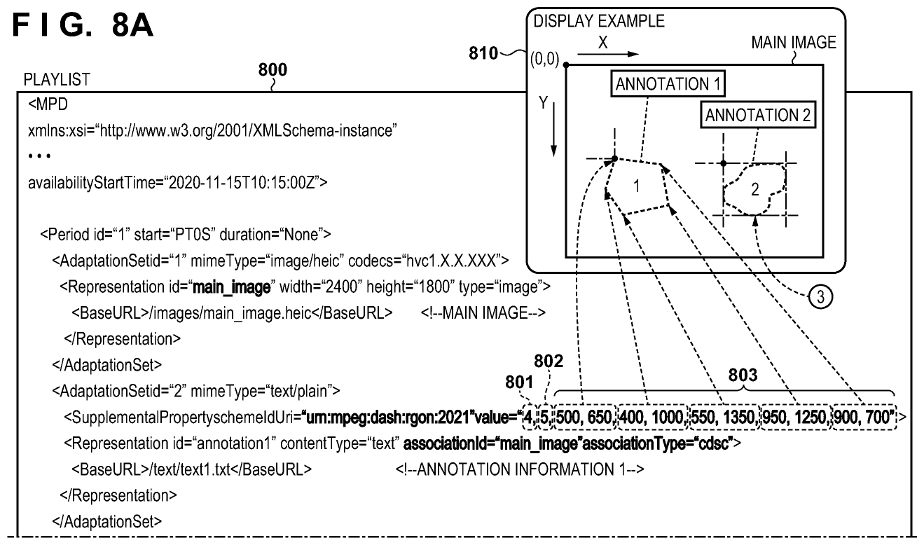

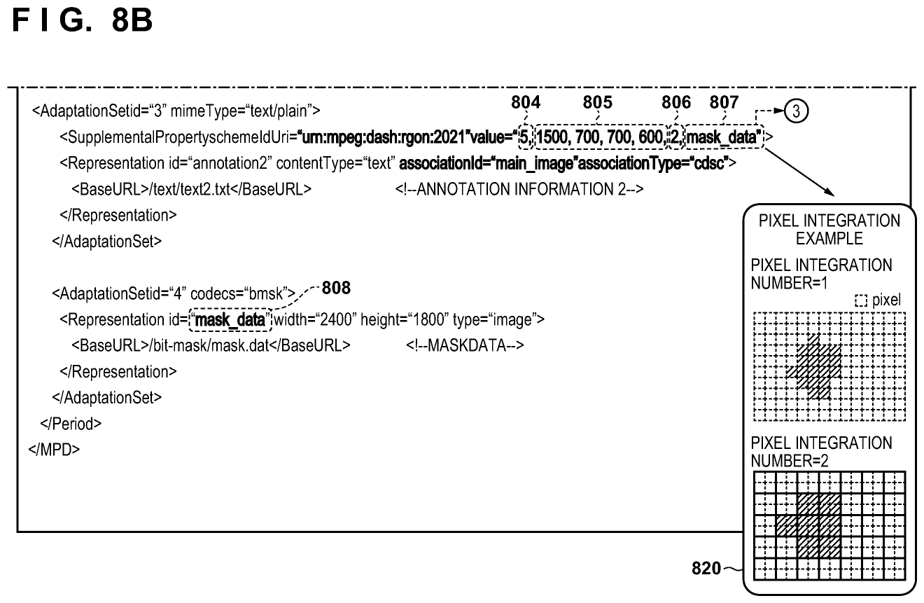

FIGS. 6A and 6B show the case in which a partial region has one of three types of shapes, namely, point, rectangular, and circular shapes. An example of using a bit mask defining a polygonal shape as a more complicated shape or arbitrarily defining a shape for each pixel will be described with reference to FIGS. 8A and 8B. FIGS. 8A and 8B show an example of describing a playlist generated by the generating unit 106 as in FIGS. 6A and 6B.

In the example shown in FIGS. 8A and 8B, as shown in a display example 810, in a playlist 800, a polygonal region (annotation 1) and a pixel designation region (a region having an arbitrary shape) (annotation 2) each are set as one partial region in the main image. The playlist 800 allows basically the same description as that of the playlist 600. In this case, annotation 1 indicates that the partial region has a polygonal shape by setting a first value 801 of “value=” to “4” and a second value 802 of “5” indicates the number of vertices of a polygon. Succeeding values 803 are the coordinates of five vertices, and a total of 10 parameters are described as the respective XY coordinates. Note that the generating unit 106 can define a straight line by setting the number of vertices to 2. In addition, the generating unit 106 may set a parameter indicating whether the coordinates of the first and last vertices are closed (are connected by a line segment). In this case, when the coordinates are closed, the resultant shape may be polygonal, whereas when the coordinates are not closed, the resultant shape may be a polygonal line.

Annotation 2 indicates that the partial region has an arbitrary shape by setting a first value 804 of “value=” to “5”. In this case, four succeeding values 805 are parameters representing a region into which the partial region is fitted, that is, representing the coordinates of the upper left corner of the arbitrary region and the horizontal and vertical sizes of the region. A succeeding value 806 is a value to be referred to when generating a reduced image by pixel integration of pixel-by-pixel information represented by a bit mask. In this case, as indicated by a pixel integration example 820, “2” is described as a value indicating a mask that reduces an image by integrating two adjacent pixels into one pixel. Generating such mask data can reduce the amount of data to about ¼. This pixel integration method may be arbitrarily set. Although “2” is described as a value to be applied to both the numbers of pixels to be integrated in the vertical and horizontal directions in the pixel integration example 820, different values may be described in the respective directions. In this case, different values may be described as one parameter in the form of, for example, “n x m” where n is the value in the vertical direction and m is the value in the horizontal direction or may be described as two parameters in the form of, for example, “n”, “m”. In the playlist 800, “mask data” set as a representation ID 808 of the mask data is described in a last value 807 of the region information parameters of annotation 2, thereby associating the region information of annotation 2 with the mask data.

Note that, according to MPEG-DASH, in order to acquire identical content while dynamically changing the bit rate or resolution, it is possible to prepare streams with different bit rates or different resolutions and describe URLs that allow the acquisition of the respective streams in MPD. This configuration makes it possible to use content with a bit rate or resolution suitable for a communication band or the processing performance of a client. In the examples shown in FIGS. 6 to 8, however, since it is assumed that the position and size of region information are set by using units such as pixels, even identical content change in coordinate information when different resolutions are set. Consequently, the coordinates may differ from those described in the playlist.

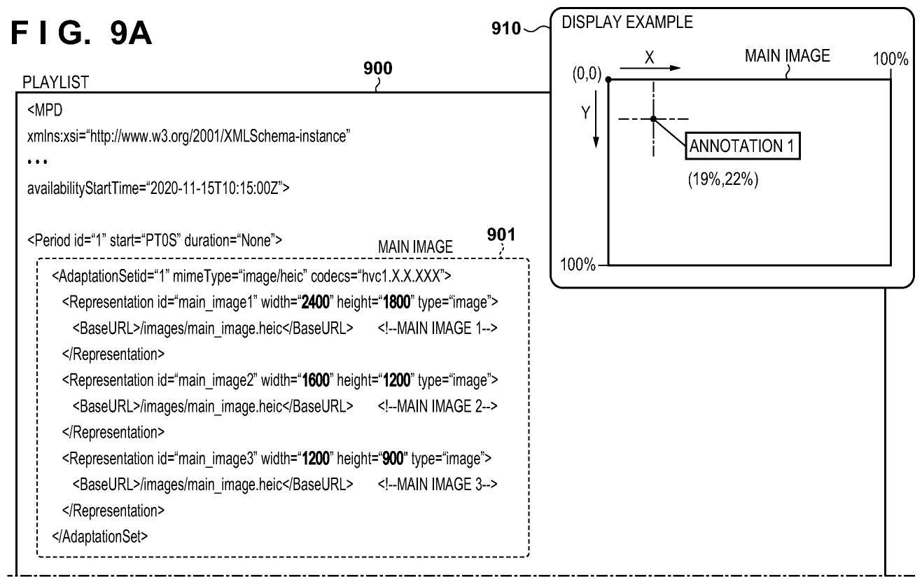

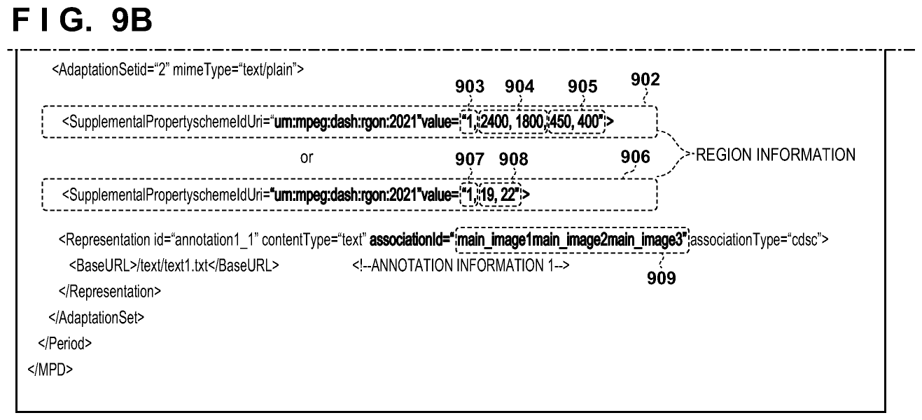

A processing example for making the scaling of region information compatible with a change in the resolution of a video in consideration of the above case will be described with reference to FIGS. 9A and 9B. FIGS. 9A and 9B show an example of a playlist in which information is described basically in the same manner as in FIGS. 6A and 6B.

As indicated by a display example 910, a playlist 900 is a description of data that associates an annotation image with one partial region of a main image 901. In the example shown in FIGS. 9A and 9B, three images with different resolutions each are described as the main image 901. In addition, region information of two patterns 902 and 906 corresponding to scaling is described.

Referring to FIGS. 9A and 9B, the region information of a partial region having a point shape is described, and two values (904) “2400, 1800” representing the resolutions of the main image are described following a first value (903) of “1” after “value=” of the region information 902. Subsequently, “450, 400” is described as a value 905 representing the position of the partial region. In this case, when the resolution of the main image changes, the generating unit 106 can generate a playlist so as to also change the position of the partial region to the corresponding position by proportional calculation. Although it is assumed that the value 904 (“2400, 1800” in the example shown in FIGS. 9A and 9B) of the main image is one of the resolutions of the main images, the value may differ in size from any of the stored main images. In this case as well, the position of the partial region can be decided to a corresponding position with respect to the main image to be used by proportional calculation. In addition, even when the partial region has a shape other than a point, the center coordinates of a circle or each length can be scaled in the same manner by proportional calculation.

Referring to FIGS. 9A and 9B, a value (908) “19, 22” representing a position by % from the upper left position of the main image is described instead of pixel coordinates following a first value (907) of “1” after “value=” of the region information 906. That is, as indicated by the display example 910, a description is generated such that a partial region is located at a position of 19% with respect to the entire X-coordinates and at a position of 22% with respect to the entire Y-coordinates. The value 908 is a value representing a relative position when the upper left end is represented by “0, 0” and the lower right end is represented by “100, 100”.

Note that in this example, since three main images with different resolutions are prepared, different representation IDs corresponding to the respective images are prepared. The example in FIGS. 9A and 9B shows the representation IDs of the main images corresponding to a value 909 of “annotationID” of annotation 1 (annotation1_1). In this case, the three representation IDs are described side by side through spaces.

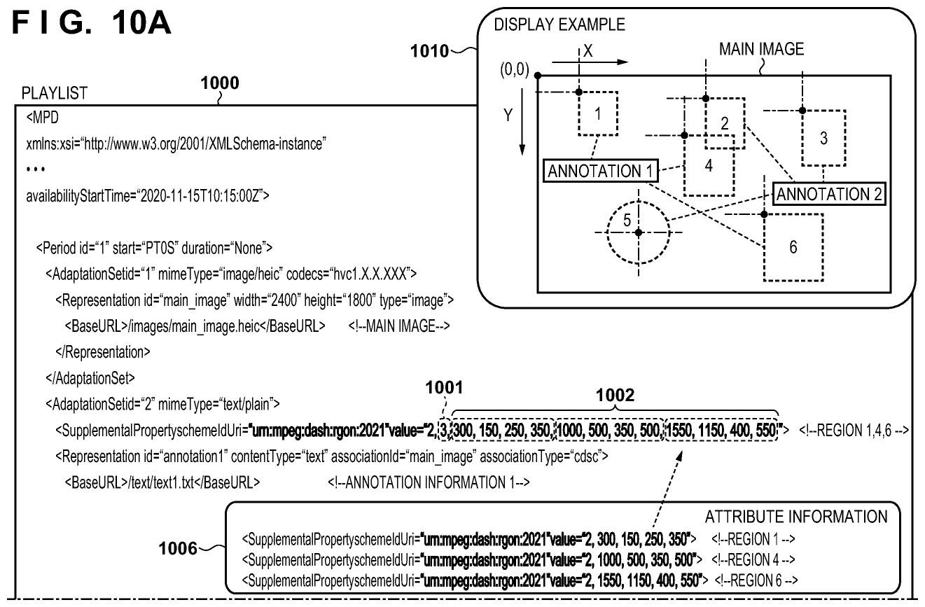

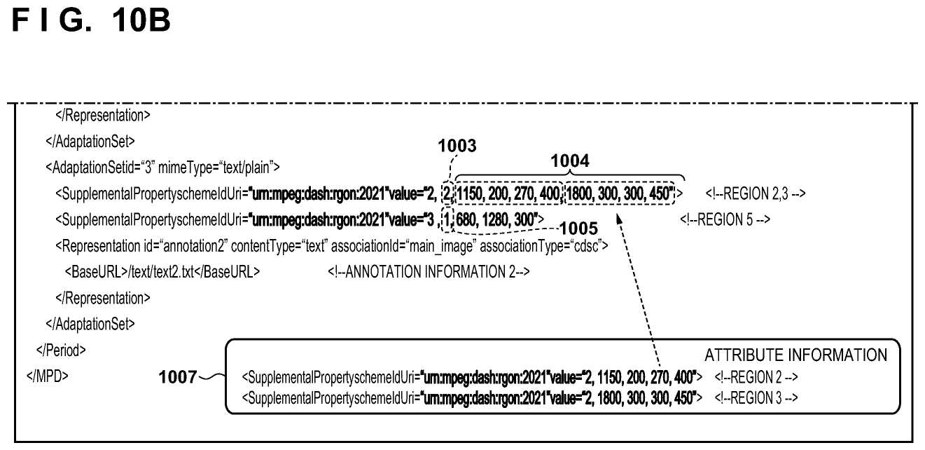

An example of associating one piece of annotation information with a plurality of different partial regions will be described next with reference to FIGS. 10 A and B. FIGS. 10A and B show an example of a playlist allowing basically the same description as that shown in FIGS. 6A and 6B.

A playlist 1000 is the description of data with the same annotation information associated with a plurality of partial regions in a main image as indicated by annotation 1 and annotation 2 in a display example 1010. In this example, annotation 1 is associated with three rectangles 1, 4, and 6 as partial regions, and annotation 2 is associated with rectangles 2 and 3 and circle 5.

In the playlist 1000, following the first value (representing the shape of the partial region) of “value=” of the region information described as the attribute information of the annotation information, a value 1001 indicating the number of corresponding partial regions is described. In the example shown in FIGS. 10A and 10B, “3” is described as the value 1001, and a succeeding value 1002 is described as a parameter indicating the positions and sizes of three partial regions. In the example shown in FIGS. 10A and 10B, since each partial region has a rectangular shape, four parameters indicating the XY coordinates and the size of each partial region are described as a total of 12 values. These values are equivalent to attribute information 1006 having the pieces of attribute information of the three partial regions described side by side, which may be described in an arbitrary manner.

In this case, the partial regions with which the same annotation information is associated may have different shapes. In the example shown in FIGS. 10A and 10B, circle 5 differs in shape from rectangles 2 and 3 with which annotation 3 is associated, and corresponding values 1003 and 1005 are separately listed.

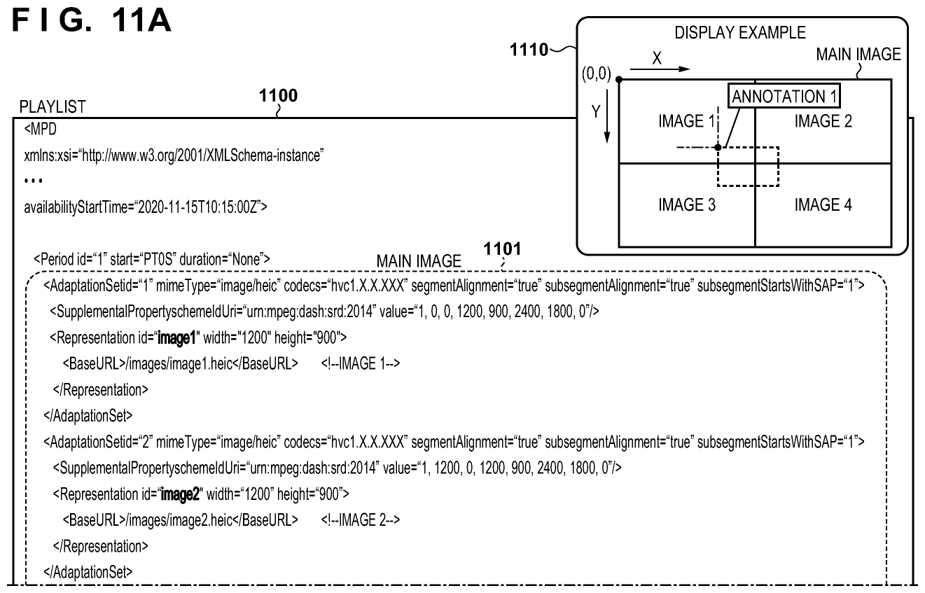

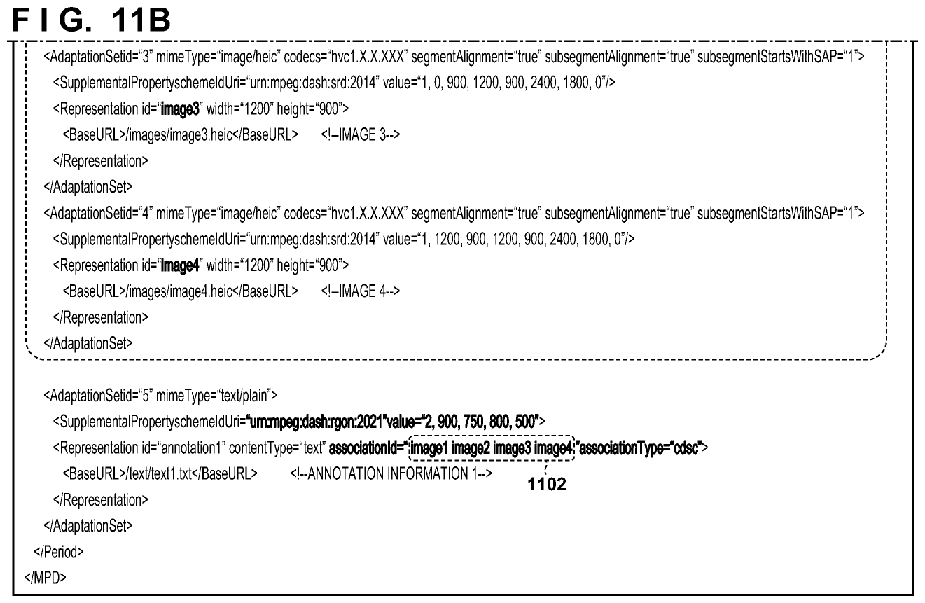

An example of displaying a plurality of image data in combination as a main image will be described with reference to FIGS. 11A and 11B. In a playlist 1100 in FIGS. 11A and 11B, as indicated by a display example 1110, four images, namely, images 1 to 4, are laid out in a tile pattern as a main image, and annotation information is associated with the partial regions in the same manner as in the example shown in FIGS. 6A and 6B.

In this case, the generating unit 106 can describe a main image 1101 by using SRD (Spatial Relationship Description), which is defined by MPEG-DASH and a technique of spatially arranging an image or video. In this case, for images 1 to 4, the representation IDs of image1 to image4 are defined. Assume that the respective images constituting the main image are arranged in the main image by a description similar to that for the partial regions in FIGS. 6 to 10. Annotation information 1 described in a lower portion of the playlist 1100 can represent a partial region by coordinates with the upper left end of the main image being the origin. Describing, in a value 1102 of “association ID”, the representation ID of an image having a region superimposed on a partial region of an image constituting the main image facilitates specifying an image concerning a partial region provided with annotation information.

Note that the images constituting a main image need not have the same size and need not be arranged in a tile pattern as in FIGS. 11A and 11B. That is, the generating unit 106 may generate a playlist so as to overlay and display images with various sizes at arbitrary coordinates. In this case, the origin at which a partial region is set can be a point obtained by combining the left end point of the leftmost image of the images constituting the main image and the upper end point of the uppermost image. However, a desired point different from the above point may be set as an origin. According to such configuration, a composite image like a panoramic image can be displayed as a main image, with annotation information being associated with a partial region set on the image.

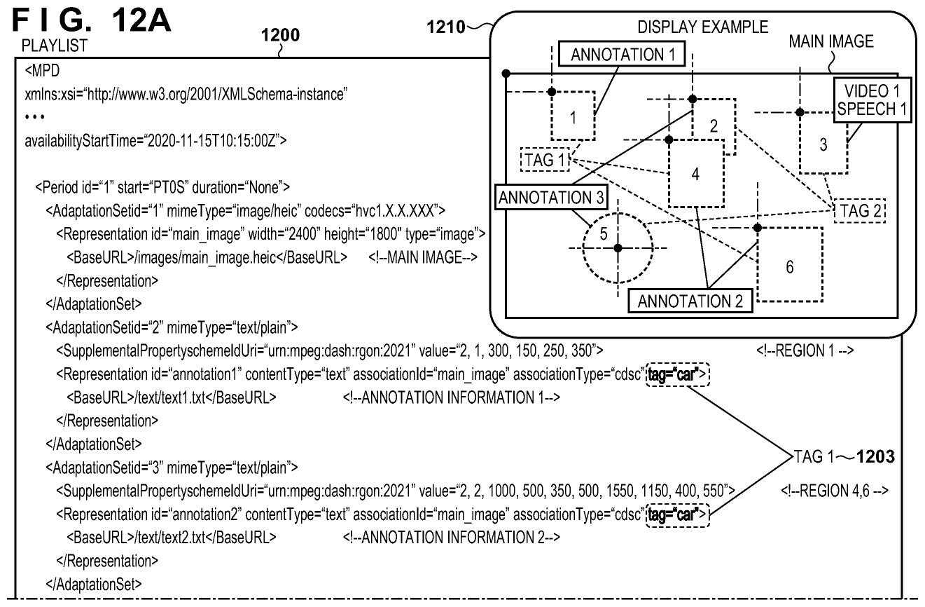

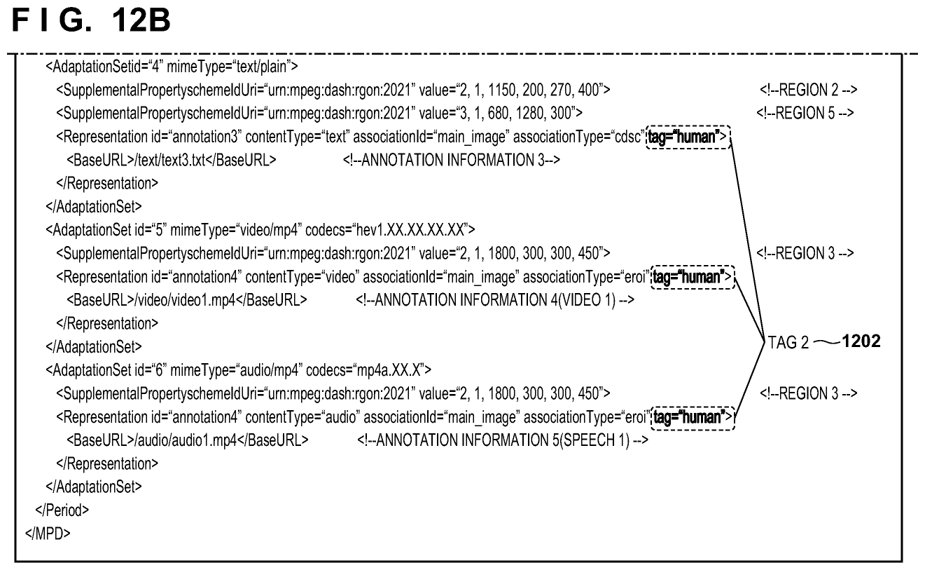

An example of providing annotation information with tag information to improve the search performance and the convenience of controlling and managing information will be described with reference to FIGS. 12A and 12B. FIGS. 12A and 12B show an example of a playlist allowing basically the same description as that shown in FIGS. 6A and 6B.

In a playlist 1200, there are six partial regions 1 to 6 provided with annotation information on a main image, and common tags are provided to the pieces of annotation information with the same attributes. In the example shown in FIGS. 12A and 12B, tag 1 (1201) “car” is defined as indicating annotation information concerning vehicle with respect to pieces of annotation information 1 and 2, and tag 2 (1202) “human” is set as indicating annotation information concerning human with respect to pieces of annotation information 3 to 5. In this case, the attribute of the pieces of annotation information 1 to 3 of the pieces of annotation information 1 to 5 is text, the attribute of annotation information 4 is video, and the attribute of annotation information 5 is speech. In addition, annotation information 3 is provided to both regions 2 and 5, and both annotation information 4 and annotation information 5 (video and speech) are provided to same region 3.

A display example 1210 is an example of displaying information described in the playlist 1200. The generating unit 106 may generate a playlist so as to display only annotation information having a specific tag or color-coded display the information in consideration of a case in which, for example, when all the pieces of annotation information are superimposed and displayed on the main image, the resultant display becomes complicated.

According to such configuration, it is possible to generate and transmit a playlist including a network for the acquisition of an image, region information defining a partial region on the image, and annotation information as information to be displayed in association with the partial region. Therefore, it is possible to generate a playlist for displaying annotation information in a partial region with respect to an input video and send the playlist to the user who requires the annotation information.

### Second Embodiment

The information processing apparatus according to the first embodiment causes the generating unit 106 to generate a playlist including region information defining a partial region and annotation information. In contrast to this, the second embodiment externally acquires region information and annotation information. The information processing apparatus according to this embodiment has a functional configuration similar to that shown in FIG. 2 and is used in a system similar to that shown in FIG. 1, and hence a redundant description will be omitted.

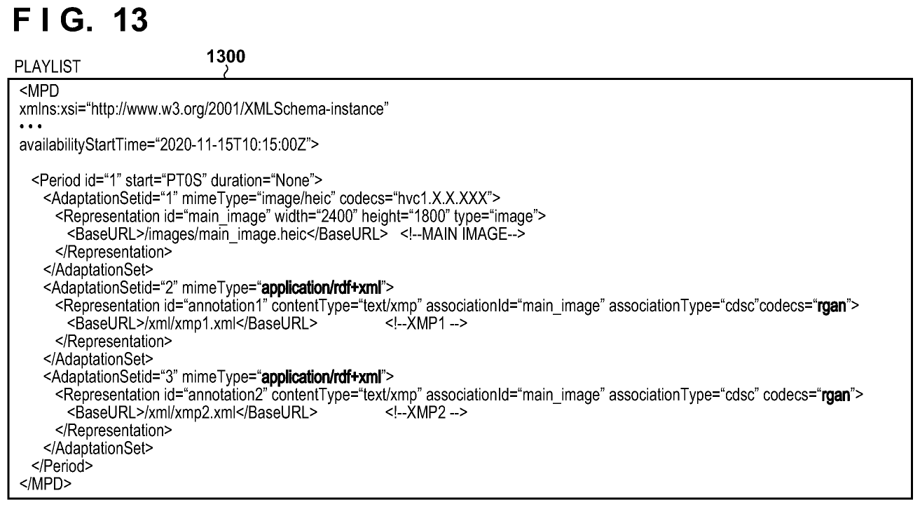

FIG. 13 shows an example of a playlist generated by a generating unit 106 according to this embodiment. In this example, in a playlist 1300, one main image and two types of information, namely, region information and annotation information, are defined. The generating unit 106 can generate a playlist including URIs for accessing each region information and each annotation information. For example, the generating unit 106 can describe region information and annotation information by XMP (Extensible Metadata Platform). In this case, the generating unit 106 may set a codec type intended to include region information and annotation information, such as “rgan(region annotation).

XMP1 and XMP2 in the playlist 1300 can be acquired by accessing the URLs described in the playlist 1300, and region information defining a partial region in the main image and annotation information associated with the region are described. The basic format of XMP is XML (Extensible Markup Language). It is preferable to describe information for acquiring a schema for interpreting the description.

The generating unit 106 may store information for performing image analysis instead of directly storing region information and annotation information. That is, the generating unit 106 may store, for example, a URI of an image analysis service, information for identifying a function used in the service, or a parameter handed to API provided by the image analysis service as information necessary to acquire region information and annotation information by image analysis. Such processing makes it possible to store information for acquiring region information and annotation information which can be generated and provided by image analysis processing without directly storing the region information and the annotation information in the playlist. In this case, the generating unit 106 may store information indicating an image analysis unit or type or algorithm. For example, the generating unit 106 can store information for identifying image analysis to be executed, such as context analysis, for example, suspicious behavior analysis in a monitoring camera, or object analysis for identifying an animal, human, vehicle, or the like. It is possible to arbitrarily use, as an object to be analyzed, an object that can be identified by general analysis processing, such as a human face or pupil, human, animal, motorcycle, number plate, or lesion portion (in medical image diagnosis or the like). In addition, there is no need to store information for performing image analysis on both region information and annotation information, and region information or annotation information may be directly stored for one of the two pieces of information.

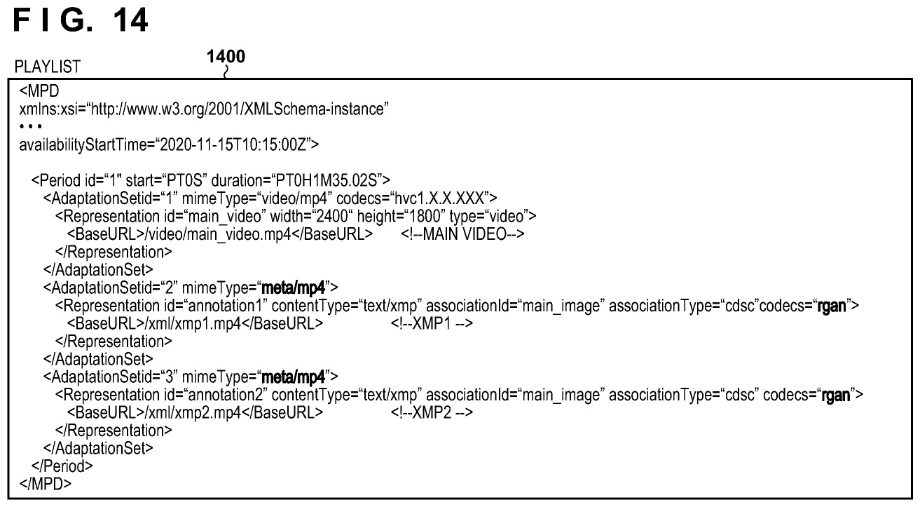

In the above examples, the processing of generating a playlist basically for a still image has been described. However, the generating unit 106 may generate a playlist including region information and annotation information for a main image as a moving image. A case in which a main image is a moving image will be described below with reference to FIG. 14.

In a playlist 1400, one main image which is a moving image and two types of information, namely, region information and annotation information, concerning the main image are defined. In this case, region information and annotation information are timed meta data having information according to time series and can be acquired as MP4 files like the mina image (moving image). Although the format of timed meta data may be an XMP/XML file as in the case in which a main image is a still image, it is preferable that there is data temporarily synchronized with the frame of the main image. In addition, when the position of a partial region is fixed even in a case in which a main image is a moving image, descriptions of region information and annotation information may be described as in the first embodiment.

Note that in MPEG-DASH and a streaming technique similar thereto, different pieces of region information can be provided for each period as the time length of each segment. Accordingly, region information may be set and updated for each period.

### Third Embodiment

The first and second embodiments each have mainly exemplified the processing by the information processing apparatus. The third embodiment exemplifies processing concerning playlist analysis and playback which is performed by a receiving apparatus 110 which has received the playlist output from an information processing apparatus 100.

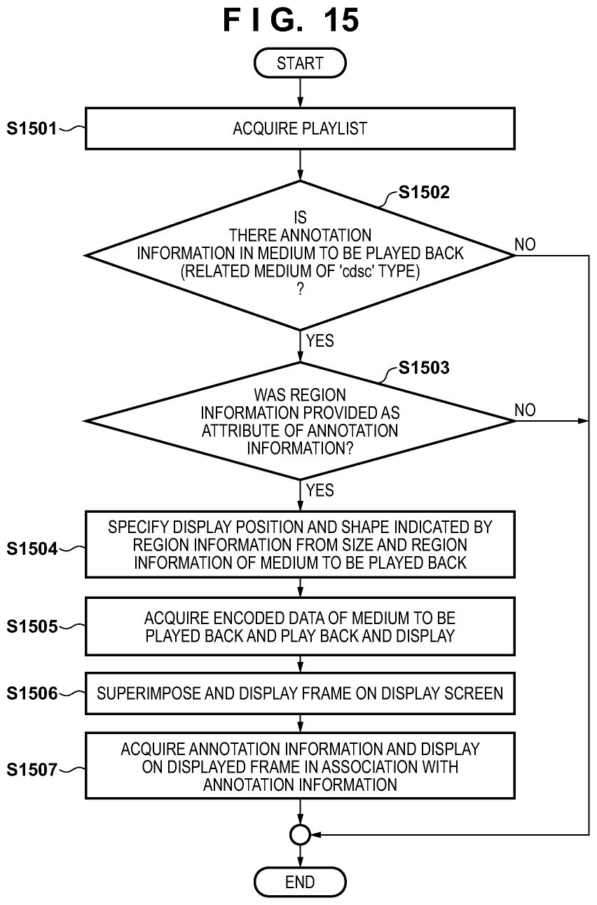

FIG. 15 is a flowchart showing an example of the processing of determining, based on analysis on a playlist, whether a video can be played back, and playing back the video, which is performed when the receiving apparatus 110 has received the playlist. The receiving apparatus 110 can read each piece of information described in a playlist by the generating unit 106 as described in the first embodiment with reference to FIGS. 6 to 13.

In step S1501, the receiving apparatus 110 acquires a playlist from the information processing apparatus 100. In step S1502, the receiving apparatus 110 determines, based on the description of the playlist, whether there is annotation information in a medium to be played back. In the example shown in FIG. 15, the representation ID of a medium to be played back is described in “associationID” in MPD, and the receiving apparatus 110 determines whether there is a medium whose “associationID” is “cdsc”. If there is such a medium, the process advances to step S1503. If there is no such medium, the processing is terminated.

In step S1503, the receiving apparatus 110 determines whether any partial region is associated with the annotation information. In this case, the receiving apparatus 110 determines whether region information is provided as the attribute of the annotation information. The region information is described as being defined by a schema like “urn:mpeg:dash:rgon:2021” as in the first embodiment. If a partial region is associated with the annotation information, the process advances to step S1504; otherwise, the processing is terminated.

In step S1504, the receiving apparatus 110 defines a partial region on the main image based on the playlist. In this case, the receiving apparatus 110 acquires the size of a medium (main image) and region information which are played back based on the description of the playlist and specifies the shape and position of the partial region.

In step S1505, the receiving apparatus 110 acquires the encoded data of a medium to be played back based on the network address described in the playlist and plays back and displays the data. In step S1506, the receiving apparatus 110 superimposes and displays a frame surrounding the partial region on the display screen displayed in step S1505. In step S1507, the receiving apparatus 110 acquires annotation information and displays the information on the display screen in association with the frame displayed in step S1506.

This processing makes it possible to acquire a video to be played back based on the information of the playlist and annotation information to be displayed in association with a partial region of the video and play back the video and the information.

### OTHER EMBODIMENTS

Although the environments have been described in detail, the present disclosure can take embodiments as a system, apparatus, method, program, recording medium (storage medium), and the like. More specifically, the present disclosure can be applied to a system including a plurality of devices (for example, a host computer, an interface device, an imaging device, and a web application) or to an apparatus including a single device.

The present disclosure can also be achieved by directly or remotely supplying programs of software for implementing the functions of the above embodiments to a system or apparatus and causing the computer of the system or apparatus to read out and execute the programs. In this case, the programs are computer-readable programs corresponding to the flowcharts shown in the accompanying drawings in the embodiments.

Accordingly, the program codes themselves which are installed in the computer to allow the computer to implement the functions/processing of the present disclosure also implement the present disclosure. That is, the present disclosure incorporates the computer programs themselves for implementing the functions/processing of the present disclosure.

In this case, each program may take any form, for example, an object code, a program executed by an interpreter, and script data supplied to an OS, as long as it has the function of the program.

Examples of the recording medium for supplying the programs includes a Floppy® disk, a hard disk, an optical disk, a magnetooptical disk, an MO, a CD-ROM, a CD-R, a CD-RW, a magnetic tape, a nonvolatile memory card, a ROM, and a DVD (DVD-ROM or DVD-R).

Methods of supplying the programs include the following. A client computer connects to a homepage on the Internet by using a browser to download each computer program itself (or a compressed file including an automatic install function) of the present disclosure from the homepage into a recording medium such as a hard disk. Alternatively, the programs can be supplied by dividing the program codes constituting each program of the present disclosure into a plurality of files, and downloading the respective files from different homepages. That is, the present disclosure also incorporates a WWW server which allows a plurality of users to download program files for causing the computer to implement the functions/processing of the present disclosure.

In addition, the programs of the present disclosure can be encrypted and stored in storage media such as CD-ROMs and be distributed to users. In this case, users who satisfy a predetermined condition are allowed to download key information for decryption from a homepage through the Internet. That is, the users can execute the encrypted programs by using the key information and make the computers install the programs.

The functions of the above embodiments are implemented by making the computer execute the readout programs. In addition, the functions of the above embodiments can also be implemented by making the OS and the like running on the computer execute part or all of actual processing based on the instructions of the programs.

The functions of the above embodiments are also implemented by writing the programs read out from the recording medium in the memory of a function expansion board inserted into the computer or a function expansion unit connected to the computer. That is, the CPU or the like of the function expansion board or function expansion unit can execute part or all of actual processing based on the instructions of the programs.

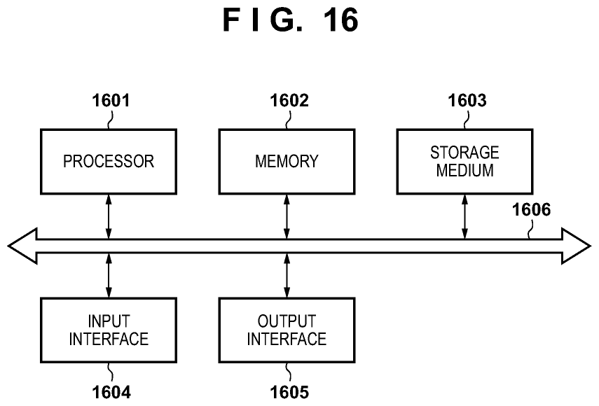

FIG. 16 shows an example of the basic configuration of such a computer. Referring to FIG. 16, a processor 1610 is, for example, a CPU, and controls the overall operation of the computer. A memory 1620 is, for example, a RAM, and temporarily stores programs and data. A computer-readable storage medium 1630 is, for example, a hard disk or CD-ROM, and stores programs and data for the long term. In this embodiment, the programs for implementing the functions of the respective units, which are stored in the storage medium 1630, are loaded in the memory 1620. The processor 1610 then operates in accordance with the programs in the memory 1620 to implement the functions of the respective units.

Referring to FIG. 16, an input interface 1640 is an interface for acquiring information from an external apparatus. An output interface 1650 is an interface for outputting information to an external apparatus. A bus 1660 connects the respective units described above and allow them to exchange data.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-165649 filed Oct. 7, 2021, which is hereby incorporated by reference herein in its entirety.

What is claimed is:

1. An information processing apparatus comprising:
a generating unit configured to generate a playlist including a network address that is referred to for acquisition of an image, region information defining a spatial partial region in the image, and annotation information that is information to be displayed in association with the partial region; and
a sending unit configured to send the playlist generated by the generating unit.

2. The apparatus according to claim 1, wherein the region information defines a position and a shape of the partial region in the image.

3. The apparatus according to claim 2, wherein the region information defines the shape of the partial region as one of a point, a rectangle, a circle, an ellipse, a polygon, and a pixel designation region.

4. The apparatus according to claim 3, wherein the region information includes the number of parameters corresponding to a shape of the partial region and indicating a position and a size of the partial region.

5. The apparatus according to claim 2, wherein a position and a shape of the partial region in the image are defined by a description of a predetermined format, and
a method of interpreting the description in the predetermined format is indicated by a schema.

6. The apparatus according to claim 2, wherein if there are a plurality of partial regions having the same shape, the generating unit generates a playlist including region information obtained by performing a description concerning the partial regions having the same shape using one element as a whole.

7. The apparatus according to claim 1, wherein if a shape of a region is designated on a pixel-by-pixel basis, the region information defines the partial region while reducing a data amount by integrating adjacent pixels.

8. The apparatus according to claim 1, wherein the partial region is one of a region indicating an object detected from the image, a region in which a predetermined event is detected by context analysis in the image, and a region designated by a user.

9. The apparatus according to claim 8, wherein the annotation information includes one of information indicating an object detected from the image and information indicating one of a unit that has specified the region, a type, and an algorithm.

10. The apparatus according to claim 8, wherein the object detected from the image is one of a human, a face, a pupil, an animal, a vehicle, a motorcycle, a number plate, and a lesion portion.

11. The apparatus according to claim 1, wherein the annotation information includes one of a text, an image, a video, and speech.

12. The apparatus according to claim 1, wherein the annotation information includes a tag indicating that the annotation information has common attribute information.

13. The apparatus according to claim 1, wherein the playlist includes a network address of an analysis service that generates one of the region information and the annotation information by performing one of image analysis and context analysis on the image.

14. The apparatus according to claim 13, wherein the playlist includes a parameter provided to the analysis service to generate one of the region information and the annotation information.

15. The apparatus according to claim 1, wherein the image is a composite image generated by combining a plurality of images.

16. The apparatus according to claim 1, wherein the playlist is Media Presentation Description defined by ISO/IEC23009-1.

17. The apparatus according to claim 1, wherein the image is an image constituting one of a still image and a moving image, and the partial region is one of a partial region of the still image and a partial region in an image of the moving image which corresponds to not less than one frame.

18. The apparatus according to claim 1, wherein the playlist includes a network address to be referred to for acquisition of one of the region information and the annotation information.

19. An information processing apparatus comprising:
a receiving unit configured to receive a playlist including a network address that is referred to for acquisition of an image, region information defining a spatial partial region in the image, and annotation information that is information to be displayed in association with the partial region;
an analyzing unit configured to analyze the received playlist;
an acquiring unit configured to acquire the image corresponding to the network address based on the analysis result; and
a display unit configured to display the partial region and the annotation information while superimposing the partial region and the annotation information on the image.

20. An information processing method comprising:
generating a playlist including a network address that is referred to for acquisition of an image, region information defining a spatial partial region in the image, and annotation information that is information to be displayed in association with the partial region; and
sending the generated playlist.

21. An information processing method comprising:
receiving a playlist including a network address that is referred to for acquisition of an image, region information defining a spatial partial region in the image, and annotation information that is information to be displayed in association with the partial region;
analyzing the received playlist;
acquiring the image corresponding to the network address based on the analysis result; and
displaying the partial region and the annotation information while superimposing the partial region and the annotation information on the image.

22. A non-transitory computer-readable storage medium storing a program which, when executed by a computer comprising a processor and a memory, causes the computer to:
generate a playlist including a network address that is referred to for acquisition of an image, region information defining a spatial partial region in the image, and annotation information that is information to be displayed in association with the partial region; and
send the generated playlist.
